(19) United States
(12) Patent Application Publication
(10) Pub. No.: US 2005/0039363 A1
(43) Pub. Date: Feb. 24, 2005

(54) Outdoor display sign and method of use thereof

(76) Inventor: Mark Galey, McDonough, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/969,282

(22) Filed: Oct. 20, 2004

(51) Int. Cl. G09F 7/00

(52) U.S. Cl. 40/607.03; 40/607.05

(57) ABSTRACT

An outdoor display sign, and method of use thereof, the outdoor display sign having first and second panels carrying indicia thereon, wherein said first and second panels have at least one, and preferably two support rods passing through the plane of each panel. The support rods extend past the top of the panel, affording a location to secure a sleeve to the top of the support rods, wherein a sleeve is located at each end of a restraining rod, such that the restraining rod forces the panels into a right angular configuration. The positioning of the panels into a right angle permits viewing of the outdoor display sign from two different directions. Alternate embodiments comprise at least two panels with restraining rods to form square and/or angled signs, and to an insertion tool for facilitating insertion of support rods into a ground surface.

### TECHNICAL FIELD

The present invention relates generally to an outdoor display sign and method of use for displaying messages, and more specifically to a foldable outdoor display sign for freestanding insertion into the ground via support legs.

### BACKGROUND OF THE INVENTION

Signage devices of great variety are seen every day. Such devices vary in size from billboards or building wall signs to traffic signs and shop marquees. One particular type of sign that is particularly prevalent is the sign that is utilized along roadway verges or swales to advertise a multitude of wares and services. Real estate services are well suited to such signs, wherein travelers may observe signs while they are in a locale looking to purchase or rent homes.

Such small inexpensive signs are typically comprised of a flat corrugated board upon which a message is typically printed on the obverse thereof; although it is understood that a message could be readily included on the reverse. Such signs are typically supported by a single rod that passes through the signboard corrugation, or by two rods spaced apart to provide improved stability. The support rods are then inserted into the ground to maintain the sign in the selected location.

Unfortunately, such signs do not provide a means for viewing portions other than the obverse or reverse thereof, and are not readily read, or cannot be read, when viewed from a location approximately ninety degrees from the faces thereof. Additionally, such signs lack great stability, since the supporting rods lie in a single plane.

Signage devices such as those of Terris (U.S. Pat. Nos. 4,176,484 and 4,176,485) teach directional indicators to instruct an observer in which direction to travel in order to locate the subject of the sign. Terris '484 and '485 provide directional arrows attached to the sign, wherein selected arrows can be removed by folding, such that only a desired arrow or group of arrows remains visible. However, Terris does not teach a foldable sign with a complete message that is visible from a direction approximately ninety degrees of arc from the face of the sign. Additionally, the signs of Terris '484 and '485 lack a means for support in a freestanding manner.

Edman (U.S. Pat. No. 4,604,820 teaches a modular sign that can be assembled from components into a supporting frame member. The sign of Edman '820 has legs for freestanding support within the ground. However, Edman '820 does not teach a foldable sign, wherein a message on the sign is visible from a location approximately ninety degrees from the face of the sign. Additionally, the legs of Edman '820 lie in a single plane and thus do not impart sufficient stability.

Sign support devices are shown in U.S. Pat. No. 4,258,494 to Borque which teaches a swinging sign that is supported on a cross arm, and in U.S. Pat. No. 4,913,389 to McCracken which teaches a stand for holding a target. While the device of Borque '494 provides for sign support, it does not teach a foldable sign having a message that is visible from a location approximately ninety degrees from the face of the sign. The device of McCracken '389 provides freestanding support, but yet again does not provide for viewing of the face of the supported target from a location ninety degrees away. Neither the device of Borque '494, nor the device of McCracken '389 provides support in more than a single point or plane.

Therefore, it is readily apparent that there is a need for an outdoor display sign and method of use thereof, wherein the outdoor display sign possesses the ability to provide bi-directional support and visibility of information with increased stability.

### BRIEF SUMMARY OF THE INVENTION

Briefly described, in a preferred embodiment, the present invention overcomes the above-mentioned disadvantages and meets the recognized need for such a device by providing an outdoor display sign and method of use thereof, wherein the outdoor display sign comprises a folding sign that is readily assembled and which permits viewing of indicia thereon from two directions, approximately ninety degrees of arc apart. Additionally, the present invention provides stability by providing support in two different planes with an interlock to provide further stability of the top edges of the sign.

According to its major aspects and broadly stated, the present invention in its preferred form is an outdoor display sign, and method of use thereof, having two panels at right angles to one another and joined together by a fold line. The two panels are each supported by at least one support rod and the support rods are tied together by a restraining rod across the top between the two panels.

More specifically, the present invention is an outdoor display sign and method of use thereof, wherein the outdoor display sign comprises first and second corrugated panels carrying indicia thereon, wherein said first and second panels have at least one, and preferably two support rods passing through the plane of each panel. The support rods extend past the top of the panel, affording a location to secure a sleeve to the top of the support rods, wherein a sleeve is located at each end of a restraining rod, such that the restraining rod forces the panels into a right angular configuration. The positioning of the panels into a right angle permits viewing of the outdoor display sign from two different directions.

Accordingly, a feature and advantage of the present invention is its ability to provide visibility of indicia from two or more directions, approximately 90 degrees apart.

Another feature and advantage of the present invention is its increased stability.

Still another feature and advantage of the present invention is its ability to be folded for ease of transport and storage.

Yet another feature and advantage of the present invention is its ease of disassembly.

Yet still another feature and advantage of the present invention is its low cost and ease of manufacture.

A further feature and advantage of the present invention is its ability to be made in different sizes and/or shapes.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of an outdoor display sign according to a preferred embodiment of the present invention;

FIG. 2 is a perspective view of an outdoor display sign according to an alternate embodiment of the present invention;

FIG. 3 is a perspective view of an outdoor display sign according to an alternate embodiment of the present invention;

FIG. 4A is a perspective view of a rod component of an outdoor display sign according to an alternate embodiment of the present invention;

FIG. 4B is a perspective view of a rod component installer and a rod component of an outdoor display sign according to an alternate embodiment of the present invention;

FIG. 4C is a perspective view of a rod component installer and a rod component of an outdoor display sign according to an alternate embodiment of the present invention;

FIG. 4D is a perspective view of an installation tool for rod components of an outdoor display sign according to an alternate embodiment of the present invention;

FIG. 4E is a perspective view of an installation tool for rod components of an outdoor display sign according to an alternate embodiment of the present invention, shown in use;

FIG. 4F is a perspective view of an installation tool and rod component of an outdoor display sign according to an alternate embodiment of the present invention; and

FIG. 4G is a perspective view of an installation tool and rod component of an outdoor display sign according to an alternate embodiment of the present invention.

### DETAILED DESCRIPTION OF THE PREFERRED AND SELECTED ALTERNATIVE EMBODIMENTS

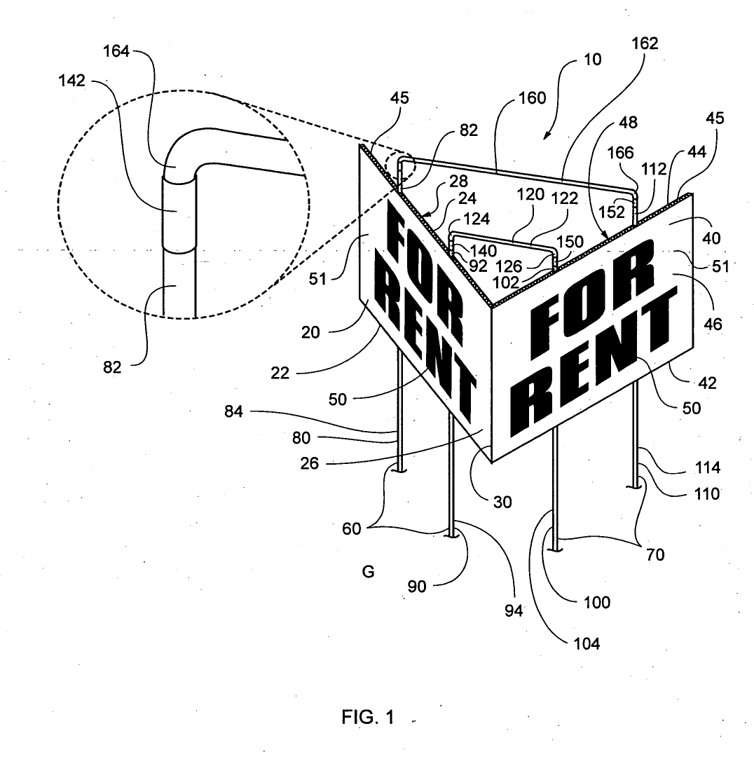

In describing the preferred and selected alternate embodiments of the present invention, as illustrated in FIGS. 1-4G, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, the present invention in a preferred embodiment is outdoor display sign 10 comprising first panel 20, fold line 30 and second panel 40, wherein first panel 20 preferably comprises first side 26 and second side 28 and wherein second panel 40 preferably comprises first side 46 and second side 48. First side 26 of first panel 20 and first side 46 of second panel 40 preferably carry indicia 50 thereon, wherein indicia 50 are preferably imprinted utilizing a waterproof pigmented coating, such as, for exemplary purposes only, ink, paint, and/or preprinted vinyl laminate sheet. It will be recognized by those in the art that other suitable coatings may be selected without departing from the present invention.

Outdoor display sign 10 is preferably comprised of any suitable material, preferably weatherproof, such as, for exemplary purposes only, corrugated metal, plastic and/or paper panels. It will be recognized by those in the art that other suitable materials could be substituted without departing from the present invention.

First panel 20 and second panel 40 are preferably formed of any suitable material, such as, for exemplary purposes only, paper, cardboard, wood, metal and/or plastic. First panel 20 and second panel 40 preferably have corrugations formed therewithin and could alternately further comprise vinyl laminate sheet 51 thereon, wherein laminate sheet 51 could comprise a vinyl sheet.

Outdoor display sign 10 is preferably supported upon first rod pair 60 and second rod pair 70, wherein first rod pair 60 preferably passes within and through corrugations 45 within the plane of first panel 20 and second rod pair 70 preferably passes within and through corrugations 45 within the plane of second panel 40. First rod pair 60 and second rod pair 70 are preferably held firmly by frictional forces from contact with corrugations 45 within the planes of first panel 20 and second panel 40.

First rod pair 60 preferably comprises first rod 80 and second rod 90 and second rod pair 70 preferably comprises first rod 100 and second rod 110. First rod 80 has tip 82 and base 84, wherein base 84 preferably extends below bottom 22 of first panel 20, and wherein tip 82 preferably extends above top 24 of first panel 20. Second rod 90 has tip 92 and base 94, wherein base 94 preferably extends below bottom 22 of first panel 20, and wherein tip 92 preferably extends above top 24 of first panel 20. First rod 100 preferably has tip 102 and base 104, wherein base 104 preferably extends below bottom 42 of second panel 40, and wherein tip 102 preferably extends above top 44 of second panel 40. Second rod 110 preferably has tip 112 and base 114, wherein base 114 preferably extends below bottom 42 of second panel 40, and wherein tip 112 preferably extends above top 44 of second panel 40.

First restraint 120 preferably comprises arm 122, first leg 124 and second leg 126. First restraint 120 is preferably of a length suitable to cause first panel 20 and second panel 40 to form an angle of approximately ninety degrees therebetween, wherein first restraint 120 is preferably removably secured to tips 92 and 102. First sleeve 140 is preferably carried by first leg 124 and second sleeve 150 is preferably carried by second leg 126. First sleeve 140 is preferably removably secured to tip 92 and second sleeve 150 is preferably removably secured to tip 102, thereby restraining first panel 20 and second panel 40 at the selected angle of approximately ninety degrees. Sleeves 140 and 150 are preferably secured via an interference fit with legs 124 and 126, respectively, and preferably via an interference fit with tips 92 and 102, respectively. It will be noted by those skilled in the art that any length of first restraint 120 can be chosen to provide for any selected angle between first panel 20 and second panel 40.

Second restraint 160 preferably comprises arm 162, first leg 164 and second leg 166. Second restraint 160 is preferably of a length suitable to complement first restraint 120 in causing first panel 20 and second panel 40 to form an angle of approximately ninety degrees therebetween, wherein second restraint 160 is preferably removably secured to tips 82 and 112. Third sleeve 142 is preferably carried by first leg 164 and fourth sleeve 152 is preferably carried by second leg 166. Third sleeve 142 is preferably removably secured to tip 82 and fourth sleeve 152 is preferably removably secured to tip 112, thereby restraining first panel 20 and second panel 40 at the selected angle of approximately ninety degrees. It will be noted by those skilled in the art that any length of second restraint 160 can be chosen to provide for any selected angle between first panel 20 and second panel 40; however, the selected length of second restraint 160 preferably complements the length of first restraint 120 in providing for the correct angle between first panel 20 and second panel 40.

Fold line 30 preferably permits placement of first panel 20 proximate second panel 40 for storage and/or transportation, thereby forming a flat configuration, reducing space, and increasing ease of carrying. In operation, outdoor display sign 10 is preferably transported in folded condition, wherein first panel 20 preferably lies proximate second panel 40. Restraints 120 and 160 are preferably separate from first panel 20 and second panel 40, but transported therewith. To assemble, first rod pair 60 and second rod pair 70 are preferably inserted through corrugations 45 of first panel 20 and second panel 40, respectively, wherein tips 82, and 92 preferably extend beyond top 24 of first panel 20 and wherein tips 102 and 112 preferably extend beyond top 44 of second panel 40.

For installation at a selected location, first panel 20 and second panel 40 are preferably moved apart from one another about fold line 30 and preferably placed such that first panel 20 and second panel 40 are approximately perpendicular to one another, while first side 26 of first panel 20 and first side 46 of second panel 40 are preferably at an angle of approximately two hundred and seventy degrees. First rod pair 60 and second rod pair 70 are preferably inserted into ground G a suitable distance to permit ground G to retain rod pairs 60 and 70 firmly therein. Restraints 120 and 160 are then preferably attached to tips 82, 92, 102 and 112 as more fully described hereinabove.

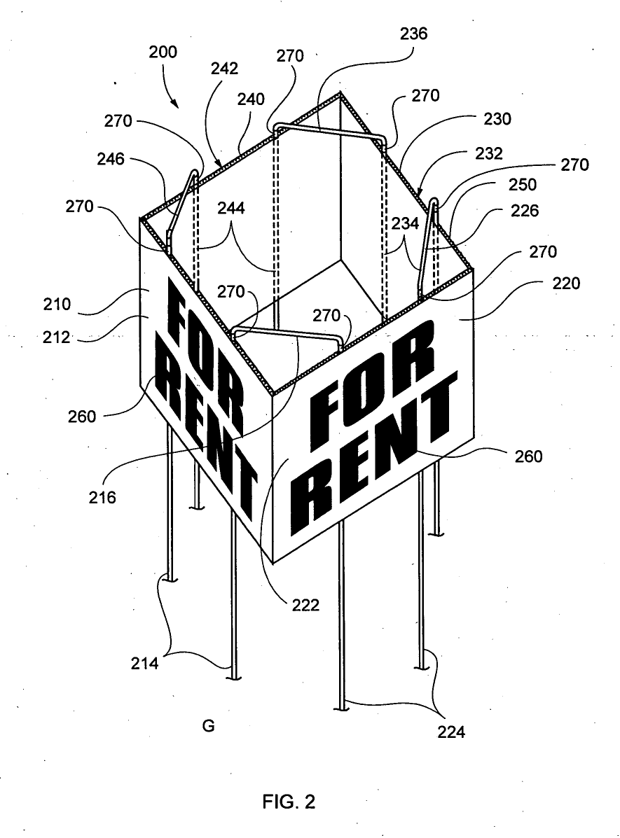

Referring now more specifically to FIG. 2, illustrated therein is an alternate embodiment of device 10, wherein the alternate embodiment of FIG. 2 is substantially equivalent in form and function to that of the preferred embodiment detailed and illustrated in FIG. 1 except as hereinafter specifically referenced. Specifically, the embodiment of FIG. 2 is multisided outdoor display sign 200 comprising first panel 210, second panel 220, third panel 230 and fourth panel 240. First panel 210, second panel 220, third panel 230, and fourth panel 240 comprises rectangle 250. Rectangle 250 has indicia 260 on outside surfaces 212, 222, 232 and 242 thereof, wherein rectangle 250 provides for visibility of indicia 260 from all viewable directions.

Multisided outdoor display sign 200 further comprises first rod pair 214, second rod pair 224, third rod pair 234 and fourth rod pair 244, wherein first support rod pair 214 is inserted into first panel 210, second support rod pair 224 is inserted into second panel 220, third support rod pair 234 is inserted into third panel 230 and fourth support rod pair 244 is inserted into fourth panel 240, and wherein support rod pairs 214, 224, 234, and 244 lie coplanar with their respective panels, 210, 220, 230 and 240.

Multisided outdoor display sign 200 further comprises first restraint 216, second restraint 226, third restraint 236 and fourth restraint 246. First restraint 216, second restraint 226, third restraint 236 and fourth restraint 246 are removably secured to first support rod pair 214, second support rod pair 224, third support rod pair 234 and fourth support rod pair 244, respectively, via sleeves 270.

It is envisioned in an alternate embodiment of the present invention that multisided display sign 200 could comprise three or more panels, three or more restraints and three or more support rod pairs.

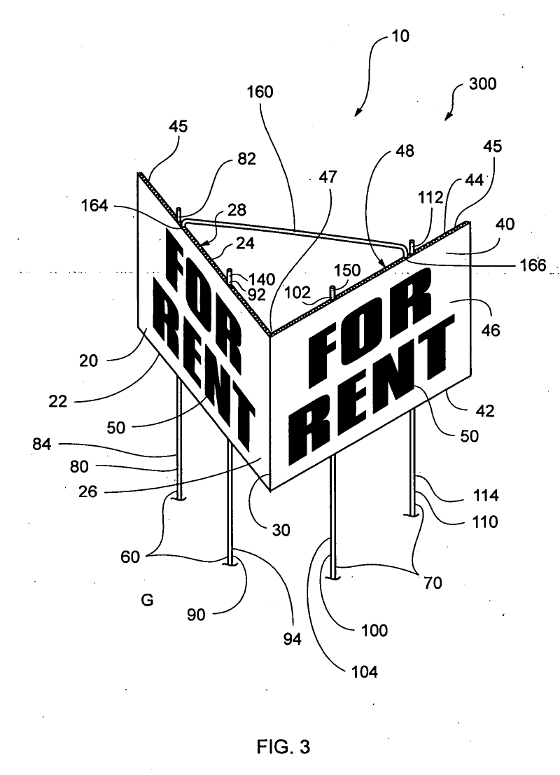

Referring now more specifically to FIG. 3, illustrated therein is an alternate embodiment of device 10, wherein the alternate embodiment of FIG. 3 is substantially equivalent in form and function to that of the preferred embodiment detailed and illustrated in FIG. 1 except as hereinafter specifically referenced. Specifically, the embodiment of FIG. 3 is multisided outdoor display sign 300 comprising first panel 20, second panel 40, restraint 160, first rod pair 60 and second rod pair 70. First rod pair 60 preferably comprises first rod 80 and second rod 90 and second rod pair 70 preferably comprises first rod 100 and second rod 110. Restraint 160 comprises first leg 164 and second leg 166.

In operation, sign 300 is assembled by inserting rods 80 and 90 through corrugations 45 of first panel 20, and inserting rods 100 and 110 through corrugations 45 of second panel 40. Subsequently, rods 80, 90, 100 and 110 are inserted into ground G such that first panel 20 and second panel 40 are held at selected angle 47 formed about fold line 30. Selected angle 47 is chosen by insertion of first end 164 and second end 166 of restraint 160 into corrugations 45 such that first panel and second panel are held at angle 47.

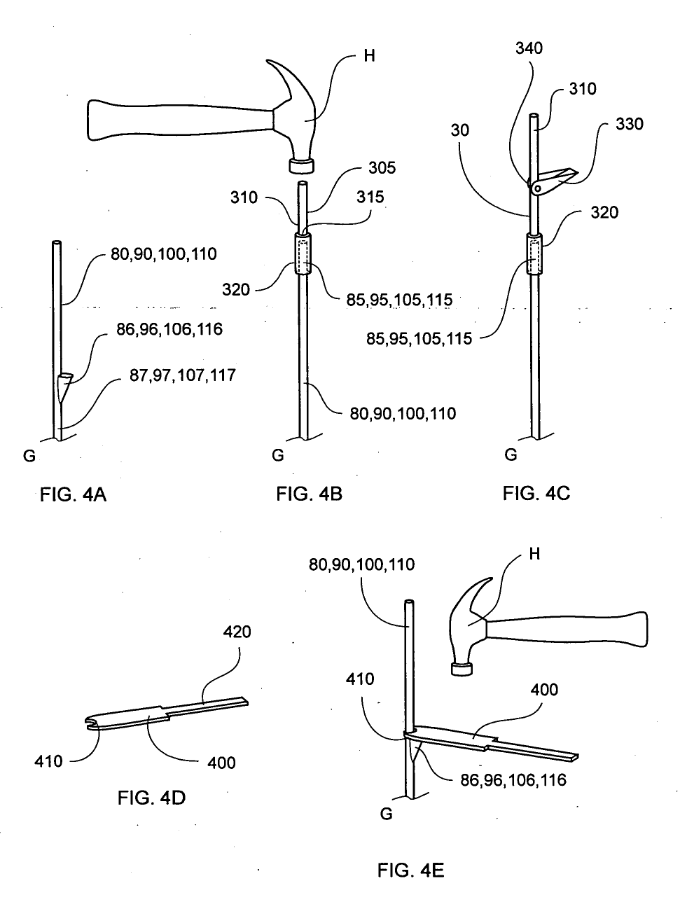

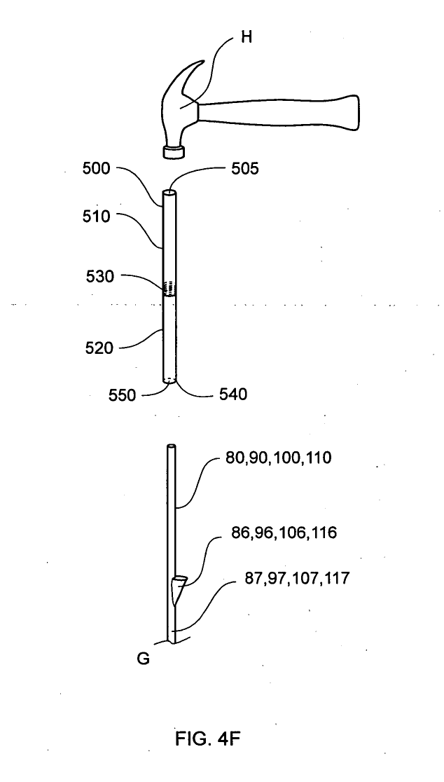

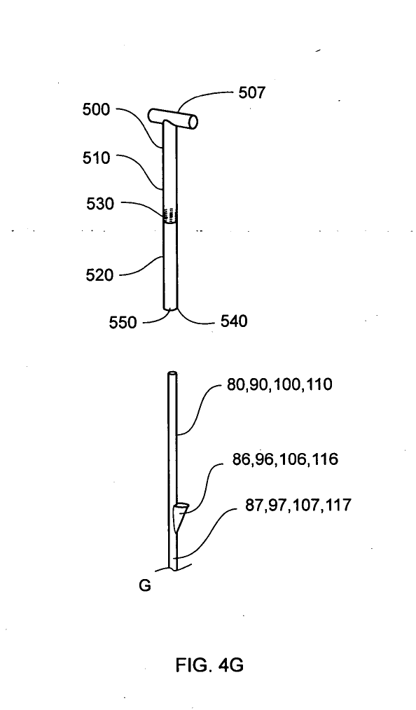

Referring now more specifically to FIGS. 4A, 4D and 4E illustrated therein is an alternate embodiment of rods 80, 90, 100 and 110 (best shown in FIGS. 4A and 4E), wherein rods 80, 90, 100 and 110 comprise ledges 86, 96, 106, and 116 at base ends 87, 97, 107 and 117, respectively, thereof. Ledges 86, 96, 106 and 116 serve to provide an anchor point for installation tool 400, wherein installation tool 400 comprises notch 410 and handle 420, and wherein notch 410 is adapted to receive rods 80, 90, 100 and 110. As best shown in FIG. 4E, installation tool 400 is placed with notch 410 proximate rods 80, 90, 100 and/or 110, and rods 80, 90, 100 and/or 110 can subsequently be driving into ground G via hammer H.

Referring now more specifically to FIG. 4B, illustrated therein is an alternate embodiment installation tool 305 for insertion of rods 80, 90, 100 and 110, wherein installation tool 305 comprises cup 320, ledge 315 and shaft 310. To install rods 80, 90, 100 and 110, cup 320 is placed over top ends rods 85, 95, 105 and/or 115 of rods 80, 90, 100 and/or 110, respectively. Hammer H is utilized to strike shaft 310, thereby driving rods 80, 90, 100 and 110 into ground G.

In an alternate embodiment of FIG. 4B, installation tool 400 could be utilized by placing notch 410 upon ledge 315, proximate shaft 310, wherein hammer H is subsequently utilized to strike installation tool 400, thereby driving rods 80, 90, 100 and 110 into ground G.

Referring now more specifically to FIG. 4C, illustrated therein is an alternate embodiment installation tool 307 for insertion of rods 80, 90, 100 and 110, wherein installation tool 307 comprises cup 320, shaft 310, movable bracket 330 and pivot 340, and wherein movable bracket 330 is movably attached to shaft 310 via pivot means 340. Opening movable bracket 330 to a horizontal disposition provides for striking movable bracket 330 with hammer H or alternately, by pushing on bracket 330, such as, for exemplary purposes only, by stepping on bracket 330.

Referring now more specifically to FIG. 4F, illustrated therein is an alternate embodiment installation tool 500, wherein installation tool 500 is tubular and comprises upper portion 510, lower portion 520, and wherein upper portion 510 and lower portion 530 are joined via threaded section 530. Upper portion 510 comprises top cap 505, and lower portion 520 comprises bottom end 540, wherein bottom end 540 has opening 550 formed therein. It will be recognized by those skilled in the art that a plurality of portions in addition to upper portion 510 and lower portion 520 could be utilized to further provide a longer version of installation tool 500.

Referring now more specifically to FIG. 4G, illustrated therein is an alternate embodiment installation tool 500, wherein installation tool 500 is similar to that shown in FIG. 4F, and wherein top cap 505 of FIG. 4F has been replaced by T-handle 507. T-handle 507 facilitates manual insertion of support rods 80, 90, 100, and 110 via installation tool 500.

In operation, installation tool 500 is placed over rods 80, 90, 100 and/or 110, wherein bottom portion 540 seats against ledges 86, 96, 106 and/or 116, respectively. By applying striking force from hammer H at top cap 505, rods 80, 90, 100 and/or 110 can be driven into ground G.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

1. An outdoor display sign comprising:
a first panel having indicia thereon;
a second panel having indicia thereon;
at least one support rod; and
at least one restraint rod, wherein said at least one restraint rod is removably secured to said at least one support rod.

2. The outdoor display sign of claim 1, wherein said at least one restraint rod comprises at least two sets of two support rods.

3. The outdoor display sign of claim 1, wherein said first panel and said second panel comprise an angle therebetween.

4. The outdoor display sign of claim 3, wherein the length of said at least one restraint rod defines said angle between said first panel and said second panel.

5. The outdoor display sign of claim 1, wherein said first panel and said second panel comprise a material having corrugations formed therein.

6. The outdoor display sign of claim 5, wherein said at least one support rod is disposed within said corrugations of said material.

7. The outdoor display sign of claim 6, wherein said at least one support rod is constrained from movement by friction from contact with said corrugations.

8. The outdoor display sign of claim 5, wherein said material is selected from a group consisting of paper, cardboard, plastic, metal, wood, and combinations thereof.

9. The outdoor display sign of claim 5, wherein said material is weatherproof.

10. The outdoor display sign of claim 1, wherein said outdoor display sign is adapted to form a flat configuration when folded up.

11. The outdoor display sign of claim 1, wherein said indicia comprise a waterproof pigmented coating.

12. The outdoor display sign of claim 1, wherein said waterproof pigmented coating is selected from the group consisting of ink, paint, vinyl sheet, and combinations thereof.

13. The outdoor display sign of claim 1, wherein said at least one support rod comprises a ledge.

14. A method of displaying information comprising the steps of:
a. obtaining an outdoor display sign, wherein said outdoor display sign comprises first panel having indicia thereon, second panel having indicia thereon, at least one support rod, and at least one restraint rod, wherein said at least one restraint rod is removably securable to said at least one support rod;
b. assembling said outdoor display sign; and
c. installing said outdoor display sign by insertion of said at least one support rod into a ground surface.

15. The method of claim 14, further comprising the step of:
d. folding said outdoor display sign.

16. The method of claim 14, further comprising the step of:
e. transporting said outdoor display sign.

17. The method of claim 14, wherein said first panel and said second panel comprise corrugated material.

18. The method of claim 14, wherein said first panel and said second panel comprise weatherproof material.

19. The method of claim 14, wherein said at least one support rod comprises at least two pairs of support rods.

20. The method of claim 14, wherein said indicia comprise a waterproof pigmented coating.

21. The method of claim 14, further comprising the step of: obtaining an installation tool.

22. The method of claim 21, wherein said step of installing said outdoor display sign by insertion of said at least one support rod into a ground surface further comprises the step of utilizing said installation tool to insert said at least one support rod into the ground surface.

23. The method of claim 21, wherein said installation tool is selected from the group consisting of devices having notches, cups, ledges, tubes, movable brackets and combinations thereof.

24. The method of claim 21, wherein said at least one support rod comprises a ledge.

25. An apparatus for displaying information visible from any direction, said apparatus comprising:
at least three panels having indicia thereon;
at least three sets of support rods; and
at least three restraining rods, wherein said at least three restraining rods are removably secured to said at least three sets of support rods.

26. An installation tool adapted to insert a rod into a ground surface, said tool comprising:
a device selected from the group consisting of devices having notches, cups, ledges, tubes, movable brackets and combinations thereof.
